(19) United States
(12) Patent Application Publication
(10) Pub. No.: US 2008/0026276 A1
(43) Pub. Date: Jan. 31, 2008

(54) Proton-Conducting Material, Solid Polymer Electrolyte Membrane, and Fuel Cell

(75) Inventor: Kohei Hase, Aichi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI, AICHI (JP)

(21) Appl. No.: 11/664,611

(22) PCT Filed: Sep. 12, 2005
(86) PCT No.: PCT/JP05/17214

§ 371 Date: Apr. 4, 2007

(30) Foreign Application Priority Data
Oct. 13, 2004 (JP) 2004-298834

(51) Int. Cl. H01M 8/10; H01B 1/12

(52) U.S. Cl. 429/33; 252/500

(57) ABSTRACT

A proton-conducting material with superior proton conductivity under non-humidified conditions or low-moisture conditions, and with high thermal and chemical stabilities that can be produced easily and at a low cost. A fuel cell that can operate at high temperature under non-humidified conditions or low-moisture conditions. The proton-conducting material has a dry weight per chemical equivalent (EW) of an ion exchange group of not more than 250 and preferably not more than 200.

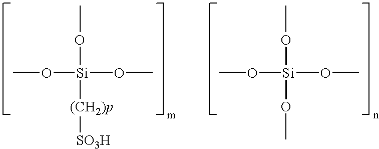

### TECHNICAL FIELD

The present invention relates to a novel proton-conducting material in which the density of proton source is increased, a method of manufacturing the same, a solid polymer electrolyte membrane, and a fuel cell employing the material, the method, and/or the membrane. More specifically, the present invention relates to a proton-conducting material and a solid polymer electrolyte membrane suitable for electrolytes and the like used for fuel cells and having proton conductivity even under non-humidified conditions.

### BACKGROUND ART

Solid polymer electrolytes are solid polymer materials having an electrolytic group in a polymer chain, such as a sulfonic group. A polymer electrolyte strongly binds to specific ions and has the property of selectively allowing positive ions or negative ions to pass through. Thus, it is formed into particles, fibers, or membranes, and used in various applications such as electrodialysis, diffusion dialysis, and battery membranes.

For example, in a fuel cell, the chemical energy of fuel is directly converted into electric energy through electrochemical oxidation of the fuel, such as hydrogen or methanol, in the cell. Thus, in recent years, fuel cells have attracted attention as a clean electric energy source. In particular, since polymer electrolyte fuel cells using a proton-exchange membrane as an electrolyte are capable of providing high power density and can be operated at low temperature, they are expected to provide a power supply for electric automobiles.

The basic structure of such polymer electrolyte fuel cells comprises an electrolyte membrane and a pair of gas diffusion electrodes having a catalyst layer, the gas diffusion electrodes being connected to both faces of the electrolyte membrane. Further, collectors are disposed on both sides of the gas diffusion electrodes. Hydrogen or methanol as a fuel is supplied to the gas diffusion electrode (anode) on one side, and oxygen or air as an oxidizer is supplied to the gas diffusion electrode (cathode) on the other side. By connecting an external load circuit between both gas diffusion electrodes, the electrodes can operate as a fuel cell. In this case, protons generated at the anode move to the cathode side through the electrolyte membrane, where the protons react with the oxygen, thereby generating water. In this case, the electrolyte membrane functions as a medium of movement for the protons and as a diaphragm for the hydrogen gas and the oxygen gas, for example. Thus, high proton conductivity, strength, and chemical stability are required for such an electrolyte.

The catalyst for the gas diffusion electrodes generally consists of a noble metal such as platinum carried on a support such as carbon having electron conductivity. A proton-conductive polymer electrolyte is used as an electrode-catalyst binder for the purpose of mediating the proton movement onto the catalyst carried on the gas diffusion electrodes and improving the usage efficiency of the catalyst. The electrolyte may consist of a fluorine-containing polymer having a sulfonic group, such as a perfluorosulfonic acid polymer, which is the same material as that of the ion-exchange membrane. In this case, the fluorine-containing polymer having a sulfonic group as the electrode-catalyst binder can be used to function as a binder for the catalyst for the gas diffusion electrodes or as a bonding agent for improving adhesion between the ion-exchange membrane and the gas diffusion electrodes.

Fluorinated electrolytes, as typified by a perfluorosulfonic acid membrane, have very high chemical stability as they have a C-F bond. Thus, fluorinated electrolytes are used as a solid polymer electrolyte membrane for halide acid electrolysis, as well as for the aforementioned fuel cells, water electrolysis, or solid polymer electrolyte membranes for brine electrolysis. Further, fluorinated electrolytes are widely applied in humidity sensors, gas sensors, oxygen condensers, and the like by utilizing their proton conductivity.

As an electrolyte membranes for fuel cells, a fluorinated membrane is mainly used, which comprises perfluoroalkylene as a major framework, partially having an ion exchange group, such as a sulfonic group or a carboxylic acid group, at the end of a perfluorovinyl ether side chain. Since the fluorinated electrolyte membrane as typified by a perfluorosulfonic acid membrane has very high chemical stability, it is valued for use as an electrolyte membrane to be used under severe conditions. Examples of such a fluorinated electrolyte membrane include a Nafion membrane (registered trademark of DuPont), a Dow membrane (Dow Chemical Company), an Aciplex membrane (registered trademark of Asahi Kasei Corporation), and a Flemion membrane (registered trademark of Asahi Glass Co., Ltd.).

The existing polymer electrolyte fuel cells are operated in a relatively low temperature range of room temperature to about 80° C. The operation temperature is limited due to the following factors.
(1) Because water is used as a proton-conducting medium, if the temperature exceeds 100° C., which is the boiling point of water, pressurization would be required and the system would be too large in scale.
(2) The fluorinated membrane used has Tg at about 130° C. Thus, in a temperature range higher than this, the ion channel structure contributing to proton conduction is destroyed. Therefore, the fuel cells are only operable at temperatures practically not greater than 100° C.

The low operation temperature leads to the disadvantage that the electricity-generating efficiency of the fuel cell becomes low. If the operation temperature could be increased to 100° C. or higher, the generating efficiency would be improved and the energy can be more efficiently used because waste heat recovery would become possible. Also, if the operation temperature could be raised to 120° C., the range of selection of catalyst materials would be expanded and cheaper fuel cells could be realized, in addition to the improvement in efficiency and the possibility of waste heat recovery.

One of the reasons for the difficulty in operation at high temperatures is the fact that the presence of water is requisite as a material to assume the role of proton transfer in the existing proton-conductive membrane. The proton conductivity of the proton-conductive membrane as typified by Nafion is greatly affected by the content of water in the membrane. If no water exists, the proton-conductive membrane does not exhibit proton conductivity. Thus, at high temperatures exceeding 100° C., pressurization is necessary, which put too much burden on the system. In particular, when the temperature exceeds 150° C., very high levels of pressurization would be necessary, which is not preferable in terms of safety as well as an increase in fuel cell costs. On the other hand, the presence of water in the membrane means that the water freezes below the freezing point, which brings about the destruction of the proton-conductive membrane.

The fact that water is necessary is a major problem when operating at room temperature to about 80° C., which are the current operating temperature. In order to allow water to be present at all times, it is necessary to feed the fuel, such as hydrogen, in a humidified conditions. However, the necessity for strict and complicated control of water content in the membrane through fuel humidification can complicate the structure of the fuel cell and can be a cause of failure, for example.

Thus, since solid electrolyte membranes based on perfluorosulfonic acids that have been conventionally suggested require water for proton conduction, it is necessary to humidify the fuel that is fed and the oxidizer. Also, due to various degradation factors, the perfluorosulfonic acid-based electrolyte membrane may discharge acid substances upon decomposition, which may affect peripheral portions. Further, because of the existence of a flexible molecule structure for improving the degree of freedom of the sulfonic acid, the perfluorosulfonic acid-based electrolyte membrane lacks stability.

In the end, the perfluorosulfonic acid-based electrolyte is problematic in that is difficult to manufacture and very expensive, and that it cannot sufficiently support the operation of fuel cells at high temperatures. Thus, there is a need to develop an ion-conductive and ion-exchange material that can support the perfluorosulfonic acid-based electrolyte.

When a proton-conductive membrane is used as a solid polymer electrolyte membrane for fuel cells, an electrolyte membrane having high ion conductivity is desired in order to minimize electric resistance upon generation of electricity. The ion conductivity of the membrane greatly depends on the number of ion exchange groups, and a fluorinated ion-exchange resin membrane with per-equivalent dry weight (EW) of about 950 to 1200 is generally used. Although a fluorinated ion-exchange resin membrane having an EW of less than 950 shows higher ion conductivity, it becomes prone to dissolution in hot and cold water. Thus, such fluorinated ion-exchange resin membrane has a great problem of durability when it is used for fuel cells.

JP Patent Publication (Kokai) No. 2002-352819 A discloses a low-EW fluorinated ion-exchange resin membrane that can be used for fuel cells. Specifically, the fluorinated ion-exchange resin membrane has a dry weight per chemical equivalent (EW) of an ion exchange group of not less than 250 and not greater than 940 and a weight decrease after a boiling process in water for eight hours of not more than 5 wt % with reference to the dry weight before such boiling process.

### DISCLOSURE OF THE INVENTION

Although the ion-exchange resin membrane disclosed in the aforementioned JP Patent Publication (Kokai) No. 2002-352819 A has a rather low EW, it comprises an ion-conductive membrane composed of a conventional perfluorosulfonic acid electrolyte. Thus the ion-exchange resin membrane is used under humidified conditions and it is difficult to raise the operation temperature thereof to 100° C. or greater. Moreover, although the EW is stated to be not less than 250 and not greater than 940, in fact, only those membranes having an EW of 614 have been prepared. The reason that the EW cannot be 600 or smaller in a perfluorosulfonic acid electrolyte is that the molecular weight of a unit having a sulfonic acid group is large and that upon synthesis of a polymer, a copolymerization unit that does not have sulfonic acid groups, such as tetrafluoroethylene, is necessary.

It is an object of the present invention to resolve the problem of the conventional solid polymer electrolyte mentioned above. It is also an object of the present invention to provide a novel proton-conducting material as an alternative to the conventional perfluorosulfonic acid electrolyte, where the value of the EW is small, proton conductivity is superior under non-humidified or low-moisture conditions, strength is superior, thermal stability and chemical stability are high, and production thereof is easy at a low cost. Further, it is an object of the present invention to realize fuel cells capable of supporting fuel cell operations at high temperatures under non-humidified conditions or low-moisture conditions.

The present invention is based on the realization that the aforementioned problems can be resolved by a polymer compound having a specific main-chain framework.

In a first aspect, the present invention provides a proton-conducting material characterized in that the dry weight per chemical equivalent (EW) of an ion exchange group is not more than 250 and preferably not more than 200. With the proton-conducting material of the present invention, it becomes possible to achieve high proton conductivity under non-humidified conditions, which has been a great problem for perfluorosulfonic acid-based electrolyte materials such as Nafion (registered trademark).

In a second aspect, the present invention provides a proton-conducting material having the following structural formula as a basic framework in terms of chemical structure: 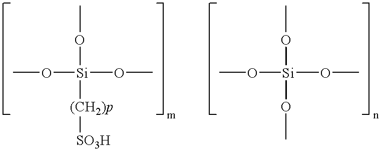
(where p is 1 to 10 and preferably 1 to 5, and m:n=100:0 to 1:99)

In the proton-conducting material of the present invention, the density of a proton source is increased. In the aforementioned structural formula, when p=1 and m:n=100:0, it is possible to achieve an EW of 147. In the second aspect of the invention of the proton-conducting material, the upper limit of the EW is not limited and values of not less than 250 are also included in the present invention. A siloxane bond (Si—O) exhibits superior high-temperature resistance.

In a third aspect, the present invention provides a solid polymer electrolyte membrane comprising one or more types of the aforementioned proton-conducting material. The polymer electrolyte membrane of the present invention shows sufficient proton conductivity under low water content conditions and no-water conditions. It is preferable to produce the proton-conducting materials via a sol-gel method to be described later, since it can provide a polymer electrolyte membrane without the necessity of a step of preparing a membrane. The method for preparing the membrane is not limited. It is possible to prepare a membrane by mixing a powder of the polymer electrolyte of the present invention with a suitable binder. It is also possible to employ general methods such as the cast method where a solution is cast on a plate, methods of coating a plate with a solution via a dye coater, a comma coater, or the like, and methods of drawing a molten polymer material.

In a fourth aspect, the present invention provides a fuel cell that uses one or more types of the aforementioned proton-conducting material. Specifically, the present invention provides a polymer electrolyte fuel cell having a membrane/electrode assembly (MEA). The MEA consists of (a) a polymer solid electrolyte membrane and (b) gas diffusion electrodes connected to the electrolyte membrane. The gas diffusion electrodes mainly consist of a conductive carrier carrying a catalyst metal and an electrode catalyst made of a proton-exchange material. The solid polymer electrolyte membrane and/or the proton-exchange material include the aforementioned polymer electrolyte or the solid polymer electrolyte membrane.

By using the polymer electrolyte and/or the polymer electrolyte membrane for the fuel cell, it becomes possible to obtain a fuel cell that enables operation under non-humidified conditions or low-moisture conditions, offering superior operation at high temperatures and superiority in mechanical strength, and that enables easy production at low cost.

In a fifth aspect, the present invention provides a method of manufacturing the aforementioned proton-conducting material. The proton-conducting material is produced using a specific silane material via a sol-gel method. In other words, using mercapto-alkyltrialkoxysilane and tetraalkoxysilane, if desired, as starting materials, a proton-conducting material having the structural formula below as a basic framework is produced via the sol-gel method. 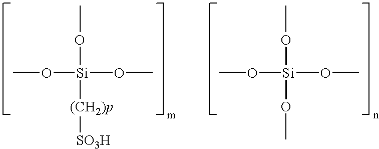
(where p is 1 to 10 and preferably 1 to 5, and m:n=100:0 to 1:99)

More specifically, as shown in the following reaction scheme, the method of producing the aforementioned proton-conducting materials comprises a step of oxidizing a mercapto group of mercapto-alkyltrialkoxysilane and, if desired, tetraalkoxysilane so as to obtain sulfonic acid, a step of obtaining a hydroxyl group using an alkoxy group of trialkoxysilane-alkylsulfonate and, if desired, tetraalkoxysilane and a step of condensing these monomer compounds. 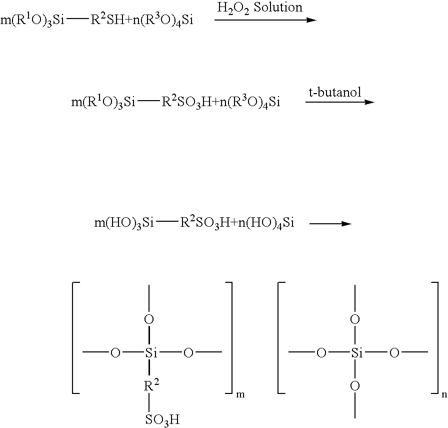
where R¹ and R³ are alkyl groups and R² is an alkylene group.

Hydrogen peroxide and t-butanol used in the step of obtaining sulfonic acid by oxidizing a mercapto group readily vaporize and are removed from the reaction system. Further, the sulfonic group (-SO₃H) generated in the step of obtaining sulfonic acid function as a catalyst in the step of obtaining a hydroxyl group using an alkoxy group. Thus, the present invention provides a very reasonable production method whereby neither reaction by-products nor impurities are generated.

In preferable examples of starting materials, the mercapto-alkyltrialkoxysilane is 3-mercaptopropyl-trimethoxysilane (MePTMS), and the tetraalkoxysilane is tetramethoxysilane (TMOS).

In the present invention, it is possible to produce a proton-conducting material having a desired EW value and to precisely design a proton-conducting material having a desired EW value by appropriately controlling the ratio of m to n shown in the aforementioned reaction scheme, namely, the ratio of the amount of mercapto-alkyltrialkoxysilane to the amount of tetraalkoxysilane. When n=0 and p=1, the minimum EW (where the density of a proton source is increased to the maximum level thereof) of 147 can be obtained. Although the upper limit of the EW is not limited, the EW is preferably not more than 250 in order to achieve high proton conductivity under non-humidified conditions.

Conventional perfluorosulfonic acid-based solid electrolyte membranes require water for proton conduction, so that the fuel supplied and the oxidizer must be humidified. By contrast, the proton-conducting materials according to the present invention exhibit sufficient proton conductivity under non-humidified conditions or low-moisture conditions. By having an EW of not more than 250, high proton conductivity on the 10⁻³ S/cm order is achieved under non-humidified conditions. Further, by increasing the density of the proton source so as to achieve an EW of not more than 200, high proton conductivity on the 10⁻² S/cm order is achieved. It becomes possible to operate a fuel cell even at high temperatures of not less than 100° C. by achieving proton conductivity under non-humidified conditions. As a result, high efficiency and high output can be achieved. And a relevant apparatus can be made smaller by simplifying the system relating to operation at low temperatures and operation under humid conditions.

### BRIEF DESCRIPTION OF THE DRAWINGS

FIG. 1 shows a graph indicating the proton-source density dependency of proton conductivity under non-humidified conditions.

FIG. 2 shows a graph indicating the temperature dependency of proton conductivity under non-humidified conditions.

FIG. 3 shows a graph indicating a comparison of proton conductivity between a proton-conducting material of the present invention and Nafion112.

### BEST MODE FOR CARRYING-OUT OF THE INVENTION

In the following, the present invention is more specifically described with reference to examples.

[Synthesis of Proton-Conducting Material]

Using 3-mercaptopropyl-trimethoxysilane (MePTMS) and tetramethoxysilane (TMOS) as starting materials, the density of proton source was increased by a sol-gel method. In the following reaction scheme, by selecting the ratio of m to n, proton-conducting materials were synthesized, such that EW was 175 when m:n=1:0, 214 when m:n=0.6:0.4, and 313 when m:n=0.3:0.7.

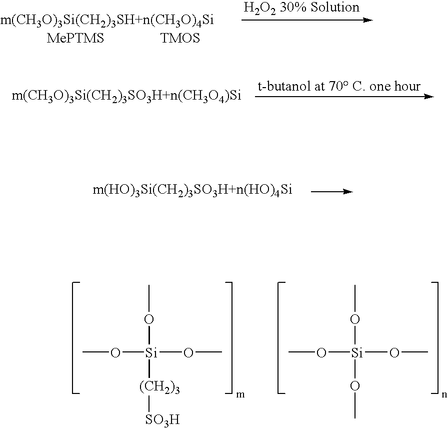

The following describes the details of individual reactions.
(1) MePTMS and TMOS were mixed with t-butyl alcohol (t-BuOH), thereby obtaining a solution A. The mixture ratio was (MePTMS+TMOS):t-BuOH=1:4 (mol ratio).
(2) A hydrogen peroxide solution in five times the volume of MePTMS (mol ratio) was mixed with t-BuOH, thereby obtaining a solution B. The mixture ratio was H₂O₂:t-BuOH=1:4 (mol ratio).
(3) The solution B was slowly added dropwise while the solution A was stirred. After the dropwise addition, the resultant solution was subjected to a heat stirring processing at 70° C. for one hour.
(4) The reacted solution was transferred to a petri dish and dried, thereby obtaining an electrolyte.

In Nafion polymers, it is difficult to precisely control the density of proton source during synthesis. However, in the aforementioned example, by changing the mol ratio of MePTMS and TMOS, the density of the proton source in the prepared gel can be precisely controlled. As the proportion of m is increased in the aforementioned example, the density of the proton source in the synthesized electrolyte can be increased. When MePTMS is used as a material, it is possible to prepare an electrolyte where the density of proton source was increased to the maximum EW of 175. When an electrolyte is synthesized in the same manner using 3-mercaptomethyl-trimethoxysilane as a synthesis material instead of MePTMS, the density of the proton source can be increased to the maximum EW of 147.

[Proton Conductivity]

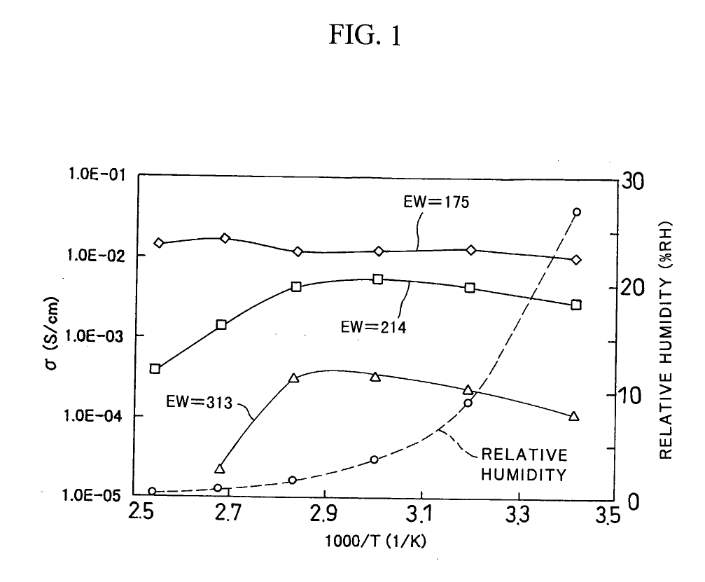

The effects of the increase in the density of proton source on proton conductivity under non-humidified conditions were examined. FIG. 1 shows proton conductivity under non-humidified conditions. When EW=313, conductivity is substantially reduced at not less than 100° C. (2.7×10^{-3/}K). This is due to a reduction in moisture content caused by the evaporation of water. By contrast, when the density of the proton source is increased up to EW=214, the overall proton conductivity is improved and the tendency of the conductivity to be decreased at not less than 100° C. is reduced. Moreover, when the density of the proton source is increased up to EW=175, the overall proton conductivity is further improved and the tendency of the conductivity to be reduced at not less than 100° C. is substantially reduced.

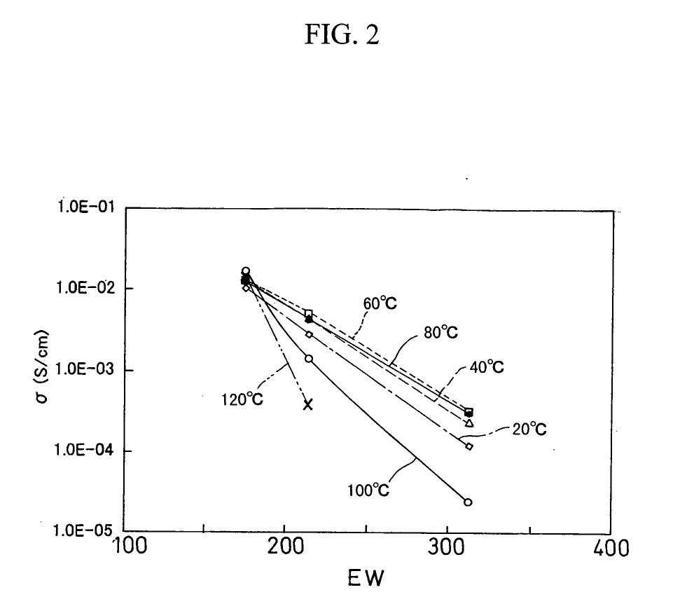

In the same manner, as shown in FIG. 2, it is learned from the relationship between the EW of synthesized electrolyte and the proton conductivity that the proton conductivity under non-humidified conditions is dependent on the EW (the density of the proton source). By increasing the density of the proton source such that the EW is 250 or less, high proton conductivity on the 10⁻³ S/cm order is achieved under non-humidified conditions. Further, by increasing the density of the proton source such that the EW is 200 or less, substantially high proton conductivity on the 10⁻² S/cm order is achieved under non-humidified conditions.

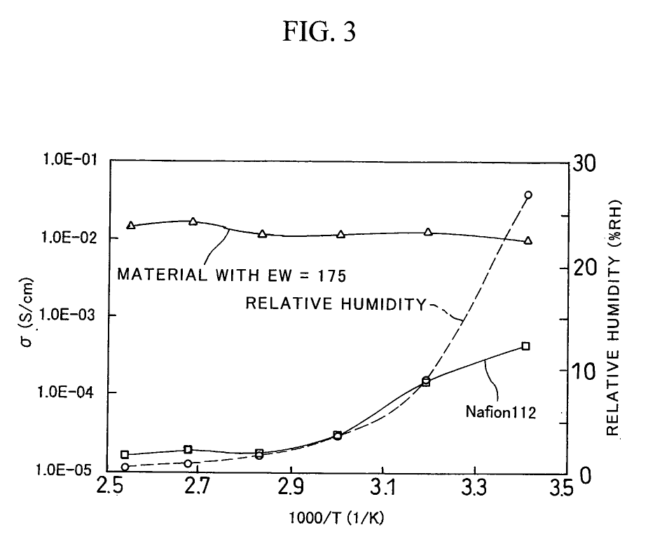

FIG. 3 shows proton conductivities measured in an electrolyte with an EW of 175 and in Nafion112 under non-humidified conditions. The electrolyte with an increased proton-source density with an EW of not more than 200 achieves proton conductivity about 1000 times higher than that of Nafion112 at 120° C. (2.5×10⁻³/K). In this manner, due to the proton source with an increased density, dependency on water is significantly reduced in comparison with Nafion112.

### INDUSTRIAL APPLICABILITY

The proton-conducting materials of the present invention exhibit sufficient proton conductivity even under non-humidified conditions or low-moisture conditions. By having an EW of not more than 250, high proton conductivity on the 10⁻³ S/cm order is achieved under non-humidified conditions. Further, by densifying the proton source so as to have an EW of not more than 200, high proton conductivity on the 10⁻² S/cm order is achieved. It becomes possible to operate a fuel cell even at high temperatures of not less than 100° C. by achieving proton conductivity under non-humidified conditions. As a result, high efficiency and high output can be promoted. And a relevant apparatus can be downsized by simplifying the system relating to operation at low temperatures and operation under humid conditions. In this manner, due to the significantly high proton conductivity at high temperatures and high heat resistance, it becomes possible to raise the operation temperature of a fuel cell and to achieve improvement in electrical efficiency, thereby effectively reducing the costs of the fuel cell.

The polymer electrolyte membrane of the present invention can be widely used for water electrolysis, halide acid electrolysis, brine electrolysis, an oxygen condenser, a humidity sensor, a gas sensor, and the like, in addition to fuel cells.

1. A proton-conducting material with a dry weight per chemical equivalent (EW) of an ion exchange group is not more than 250.

2. The proton-conducting material according to claim 1, wherein the EW is not more than 200.

3. A proton-conducting material comprising a structural formula shown below as a basic framework: 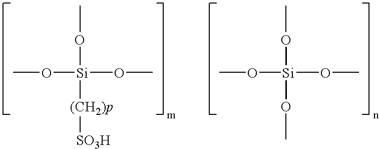
where p is 1 to 10 and preferably 1 to 5, and m:n=100:0 to 1:99.

4. A polymer electrolyte membrane comprising one or more types of the proton-conducting material according to claim 1.

5. A fuel cell comprising one or more types of the proton-conducting material according to claim 1.

6. A method for producing a proton-conducting material, whereby mercapto-alkyltrialkoxysilane and, if desired, tetraalkoxysilane are used as starting materials, and a proton-conducting material having a structural formula shown below as a basic framework is produced by a sol-gel method: 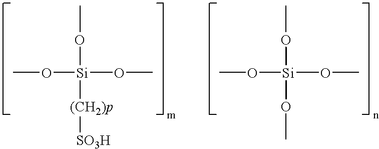
where p is 1 to 10 and preferably 1 to 5, and m:n=100:0 to 1:99.

7. The method for producing a proton-conducting material according to claim 6, comprising the steps of:
oxidizing mercapto groups of mercapto-alkyltrialkoxysilane and, if desired, tetraalkoxysilane thereby obtaining sulfonic acid;
turning an alkoxy group of trialkoxysilane-alkylsulfonate and, if desired, tetraalkoxysilane into a hydroxyl group; and
condensing these monomer compounds.

8. The method for producing a proton-conducting material according to claim 6, wherein the mercapto-alkyltrialkoxysilane is 3-mercaptopropyl-trimethoxysilane (MePTMS) and the tetraalkoxysilane is tetramethoxysilane (TMOS).

9. The method for producing a proton-conducting material according to claim 6, wherein a proton-conducting material having a desired EW value is produced by appropriately controlling the ratio of the amount of the mercapto-alkyltrialkoxysilane to the amount of the tetraalkoxysilane.

10. A polymer electrolyte membrane comprising one or more types of the proton-conducting material according to claim 2.

11. A polymer electrolyte membrane comprising one or more types of the proton-conducting material according to claim 3.

12. A fuel cell comprising one or more types of the proton-conducting material according to claim 2.

13. A fuel cell comprising one or more types of the proton-conducting material according to claim 3.

14. The method for producing a proton-conducting material according to claim 7, wherein the mercapto-alkyltrialkoxysilane is 3-mercaptopropyl-trimethoxysilane (MePTMS) and the tetraalkoxysilane is tetramethoxysilane (TMOS).

15. The method for producing a proton-conducting material according to claim 7, wherein a proton-conducting material having a desired EW value is produced by appropriately controlling the ratio of the amount of the mercapto-alkyltrialkoxysilane to the amount of the tetraalkoxysilane.

16. The method for producing a proton-conducting material according to claim 8, wherein a proton-conducting material having a desired EW value is produced by appropriately controlling the ratio of the amount of the mercapto-alkyltrialkoxysilane to the amount of the tetraalkoxysilane.

17. The method for producing a proton-conducting material according to claim 14, wherein a proton-conducting material having a desired EW value is produced by appropriately controlling the ratio of the amount of the mercapto-alkyltrialkoxysilane to the amount of the tetraalkoxysilane.
